(19) United States
(12) Patent Application Publication
(10) Pub. No.: US 2003/0194579 A1
(43) Pub. Date: Oct. 16, 2003

(54) Yellow light emitting compound and organic electroluminescent device of the same

(75) Inventor: Sung Koo Lee, Gyeonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/347,690

(22) Filed: Jan. 22, 2003

(30) Foreign Application Priority Data
Jan. 26, 2002 (KR) P2002-4624

(51) Int. Cl. H05B 33/14; C09K 11/06

(52) U.S. Cl. 428/690; 428/917; 252/301.16; 313/504; 546/66; 546/71

(57) ABSTRACT

Organic EL device having an organic EL layer with a structural formula 1 below or a dopant with a structural formula 1 below.

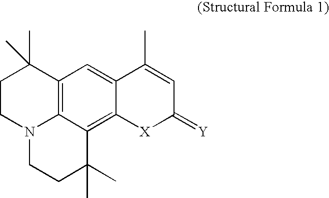

Where, X represents O, S, or N—R, wherein R represents a hydrogen, an aliphatic hydrocarbon, or a heterocyclic compound, and Y represent an alkyl group, a cyclic compound, or a heterocyclic compound containing at least one electron absorptive group.

This application claims the benefit of the Korean Application No. P 2002-4624 filed on Jan. 26, 2002, which is hereby incorporated by reference.

### BACKGROUND OF THE INVENTION

1. Field of the Invention

The present invention relates to yellow light emitting compound, and more particularly, to yellow light emitting compound and organic electroluminescent (EL) device of the same.

2. Background of the Related Art

The organic EL device, interested as a next generation flat display, has advantages in that a luminance efficiency is high, operable at a voltage lower than 15V, various colors are available, and the organic EL device is luminescent for itself, and has an angle of view greater 160°. Moreover, an organic EL device module can be fabricated to a thickness below 2 mm in total on a plastic substrate with a thickness below 0.3 mm. Thus, the organic EL display is suitable for a panel of a portable terminal that requires being thin and light weighted, has a fast response speed facilitating display of graphic or moving picture. Also, the organic EL display has a simple fabrication process favorable for mass production that permits to drop a production cost below a TFT-LCD.

The organic EL display is a device which becomes luminescent when a charge is provided to an organic film formed between a cathode (electron injection electrode) and an anode (a hole injection electrode) as the electron and the hole form a pair, and cancels each other.

In general, the organic EL display is provided with the cathode, the anode, and a luminescent medium between the anode and the cathode. In general, the luminescent medium has multiple layers, inclusive of a layer for having an electron injected therein and transporting the electron (an electron injection layer and/or an electron transporting layer), a layer for having a hole injected therein and transporting the hole (a hole injection layer and/or a hole transporting layer), and a layer for emitting a light (a luminescent layer).

The formation of the luminescent medium of an organic material like the organic EL display has an advantage in that a variety of emission light colors are available since compounding of different materials is possible. The organic material may be a polymer or a non-polymer (monomer, or oligomer), wherein the non-polymer is preferably, since the non-polymer provides a thin film more uniform than the polymer, excellent luminance and light emission efficiency, and full color with easy. As the non-polymer, there are a variety of materials, such as diamine, TPD derivatives, styryl group and the like.

Presently, though lots of researches and developments have been made on a luminescent layer that emits either one of the primary three color of green, blue and red light, no active researches and developments have been made on a luminescent layer that emits a yellow light.

### SUMMARY OF THE INVENTION

Accordingly, the present invention is directed to a yellow light emitting compound and an organic electroluminescent (EL) device of the same that substantially obviates one or more of the problems due to limitations and disadvantages of the related art.

An object of the present invention is to provide a yellow light emitting compound, and organic electroluminescent (EL) device of the same which can enhance a fluorescent efficiency, and provide a yellow light.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the organic EL device having an organic EL layer with a structural formula 1 below or a dopant with a structural formula 1 below.

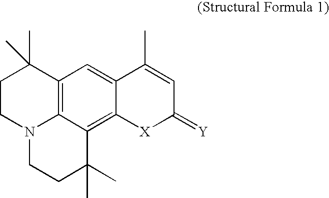

Where, X represents O, S, or N—R, wherein R represents a hydrogen, an aliphatic hydrocarbon, or a heterocyclic compound, and Y represent an alkyl group, a cyclic compound, or a heterocyclic compound containing at least one electron absorptive group.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a graph showing an EL efficiency of a yellow light emitting compound in accordance with a preferred embodiment of the present invention;

FIG. 2 illustrates a graph showing an EL spectrum of a yellow light emitting compound in accordance with a preferred embodiment of the present invention; and

### DETAILED DESCRIPTION OF THE PREFERRED EMBODIMENT

Reference will now be made in detail to the preferred embodiments of the present invention, examples of which are illustrated in the accompanying drawings.

The present invention suggests a yellow light emitting compound having the following formula.

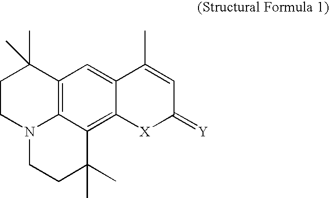

Where, X represents O, S, or N—R, wherein R represents a hydrogen, an aliphatic hydrocarbon, or a heterocyclic compound, and Y represent an alkyl group, a cyclic compound, or a heterocyclic compound containing at least one electron absorptive group. As examples of the electron absorptive group, there are cyano group, oxycarbonyl group, acyl group, sulfonyl group, and carbamoyl group.

In detail, the present invention suggests yellow light emitting compounds of the following formulae.

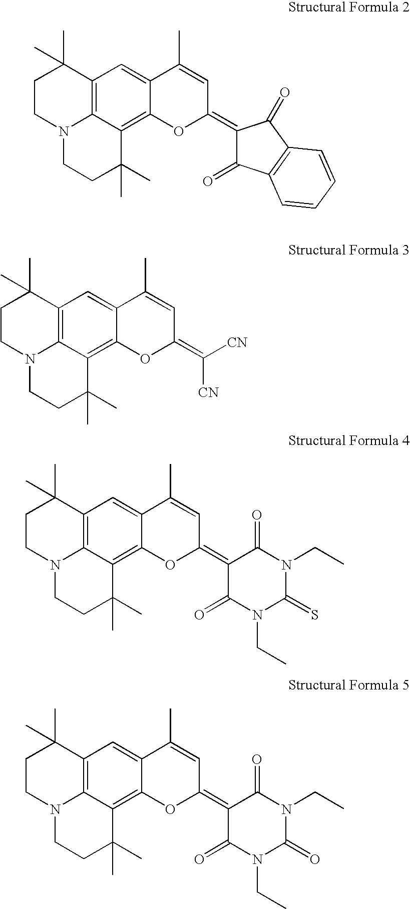

In the meantime, the organic EL device of the present invention includes a first electrode, a second electrode, and an organic EL layer between the two electrodes. The organic EL layer may be formed of one of the yellow light emitting compounds represented with structural formulae 1˜5, or may contain one of the yellow light emitting compounds represented with structural formulae 1˜5 as dopant.

Preferably, the organic EL device of the present invention includes in an order of a first electrode, a hole injection hole layer, a hole transporting layer, an organic EL layer, an electron transporting layer, an electron injection layer, and a second electrode on a transparent substrate.

The foregoing organic EL device is fabricated by the following process.

(1) Stripes of the first electrodes (anodes) are formed on a transparent substrate. The first electrode is formed of ITO.

(2) The hole injection layer is formed on the first electrode. The hole injection layer is mostly formed of copper phthalocyanine to a thickness of approx. 20˜80 Å.

(3) The hole transporting layer is formed on the hole injection layer. The hole transporting layer is formed of NPD (4,4′-bis[N-(1-naphthyl)-N-phenylamino]-biphenyl) to a thickness of approx. 300˜500 Å.

(4) The organic EL layer is formed on the hole transporting layer. The organic EL layer is formed of Alq3 (tris(8-hydroxy-quinolate)aluminum) as a host material, and the compound of the present invention as a dopant to a thickness of approx. 200˜700 Å.

(5) The electron transporting layer and the electron injection layer are formed on the organic EL layer. However, the electron transporting layer and the electron injection layer are formed, not separately, but the electron injection layer only. Because the Alq3 of the electron injection layer has a good electron transporting capability.

(6) Then, the second electrode is formed on the electron injection layer, and a protection film is covered on an entire surface.

Compounding examples and embodiments of the present invention will be explained in detail.

The following compounding example is a method for preparing the yellow light emitting compound of the structural formula 2, and the following embodiment is a method for fabricating an organic EL device formed of the yellow light emitting compound of the structural formula 2.

### COMPOUNDING EXAMPLE

A method for preparing the compound of the structural formula 2 is as follows.

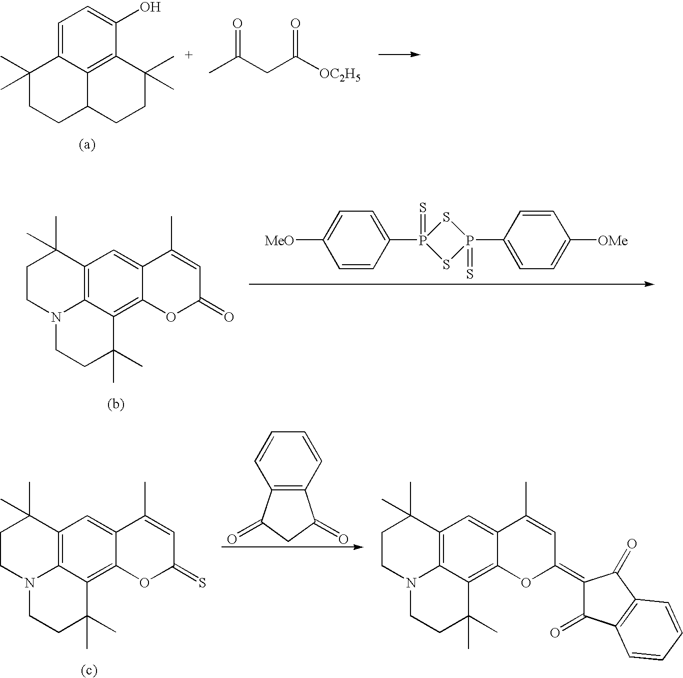

1) Compounding the Intermediate (b)

5.1 g of compound (a), 3.4 g of zinc chloride, and 3.6 g of aceto acetyl ethyl ester are mixed, and heated for 6 hours at 150° C. after cooling down heated mixture to room temperature, the mixture is subjected to layer separation by using a water solution of chloroform and sodium hydroxide. An organic phase is recovered from the layer separated solution, decompressed to remove solvent, and has impurities removed therefrom by silica gel chromatography. Then, a substance having the impurity removed therefrom is re-crystallized by a solution of hexane and ethyl acetate, to obtain 5 g of (b) product.

2) Compounding the Intermediate (c)

1.5 g of the intermediate (b) obtained in the step (1) and 1.1 g of Lawesson reagent are put into 20 ml toluene, and subjected to reaction for four hours while refluxing. The reactant is cooled down to a room temperature, decompressed to remove the toluene, then, has impurities removed therefrom by silica gel chromatography, and re-crystallized in ethanol, to obtain 1.4 q of (c) product.

3) Compounding the Final Product (d)

1 g of silver nitrate is put into 20 ml acetonitril, and stirred for 30 minutes. Then, the intermediate (c) obtained in the step (2) and 1,3-indandione 0.65 g are added to above mixture, and stirred for an hour at a room temperature. Then, when the stirring is finished, 0.8 ml of triethylamine is added to the mixture, and further stirred for four hours at a room temperature. Then, when the stirring is finished, solvent is removed from the mixture, and the mixture is re-crystallized by a solution of hexane and ethylacetate, to obtain a 1 g pf final product (d).

<Embodiment>

The organic EL device of the yellow light emitting compound of the structural formula 2 of the present invention is fabricated as follows.

After an ITO electrode is formed on a glass substrate, approx. 50 Å of copper phthalocyanine is deposited thereon, and approx. 400 Å of NPD is deposited thereon. Then, approx. 700 Å of Alq3 is deposited on the NPD, and 1% of the yellow light emitting compound of the structural formula 2 compounded according to the present invention is doped into Alq3, to form an organic EL layer. Then, aluminum is deposited on the organic EL layer, to form an electrode.

When 10V is applied to the device fabricated thus, the device emits a light with a luminance of 2300 cd/m², an light emission efficiency of 12.5 cd/A, and a chromaticity of (0.50, 0.49).

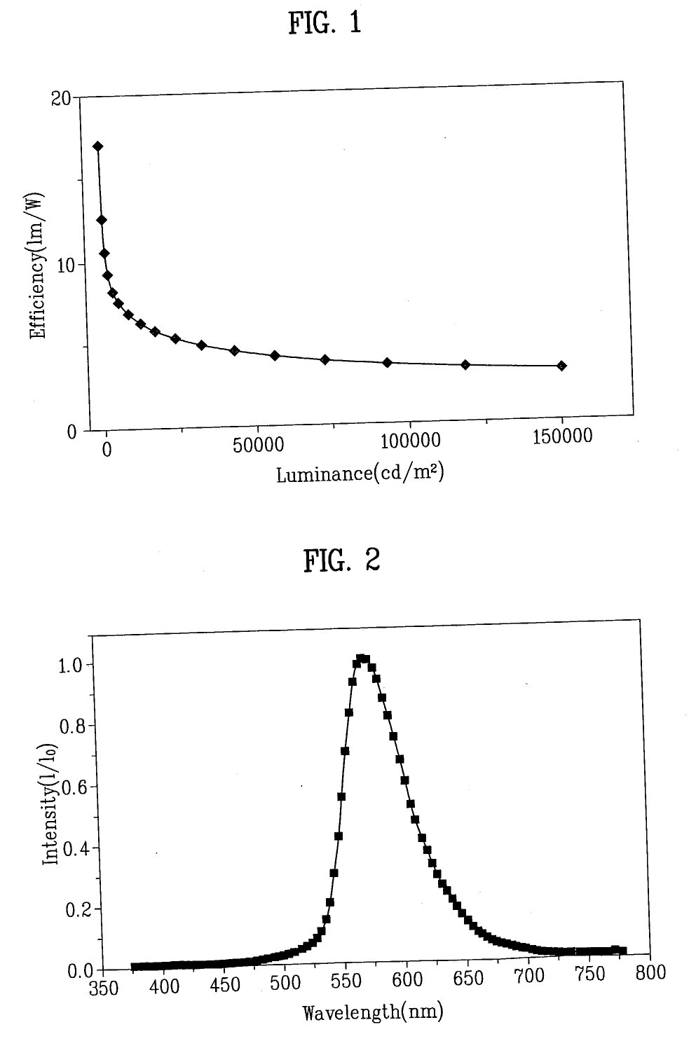

FIGS. 1˜2 illustrate graphs showing an EL efficiency and an EL spectrum, respectively.

The formation of an EL layer of a newly prepared yellow light emitting compound permits to enhance a light emitting efficiency of the organic EL device, and to obtain a yellow color.

It will be apparent to those skilled in the art that various modifications and variations can be made in the yellow light emitting compound and organic electroluminescent (EL) device of the same of the present invention without departing from the spirit or scope of the invention. Thus, it is intended that the present invention cover the modifications and variations of this invention provided they come within the scope of the appended claims and their equivalents.

What is claimed is:

1. A yellow light emitting compound having the following structural formula 1. 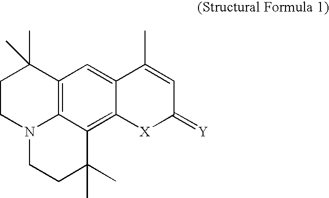
Where, X represents O, S, or N—R, wherein R represents a hydrogen, an aliphatic hydrocarbon, or a heterocyclic compound, and Y represent an alkyl group, a cyclic compound, or a heterocyclic compound containing at least one electron absorptive group.

2. A yellow light emitting compound as claimed in claim 1, wherein the electron absorptive group is selected from a group including cyano group, oxycarbonyl group, acyl group, sulfonyl group, and carbamoyl group.

3. A yellow light emitting compound as claimed in claim 2, wherein the yellow light emitting compound having the electron absorptive group has the following structural formula 2.

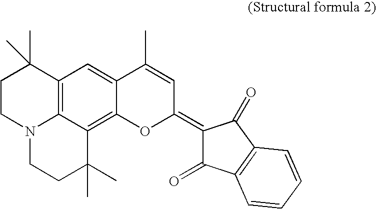

4. A yellow light emitting compound as claimed in claim 2, wherein the yellow light emitting compound having the electron absorptive group has the following structural formula 3.

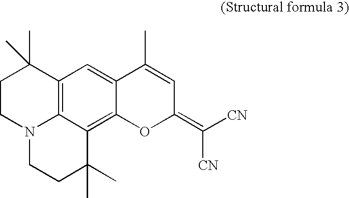

5. A yellow light emitting compound as claimed in claim 2, wherein the yellow light emitting compound having the electron absorptive group has the following structural formula 4.

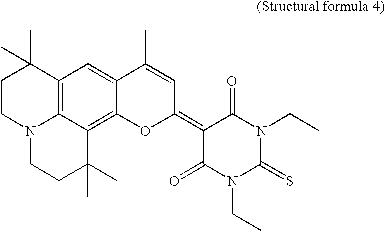

6. A yellow light emitting compound as claimed in claim 2, wherein the yellow light emitting compound having the electron absorptive group has the following structural formula 5.

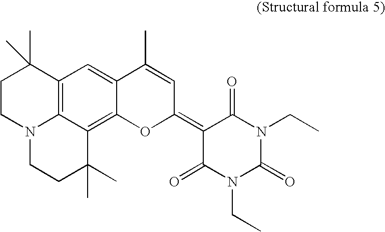

7. An organic EL display having a first electrode, a second electrode, and an organic EL layer formed between the two electrodes, wherein the organic EL layer consists of a yellow light emitting compound having a structural formula 1. 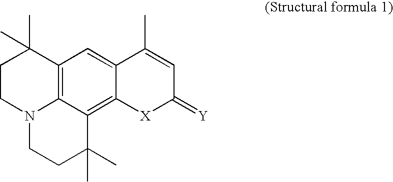
Where, X represents O, S, or N—R, wherein R represents a hydrogen, an aliphatic hydrocarbon, or a heterocyclic compound, and Y represent an alkyl group, a cyclic compound, or a heterocyclic compound containing at least one electron absorptive group.

8. A yellow light emitting compound as claimed in claim 7, wherein the electron absorptive group is selected from a group including cyano group, oxycarbonyl group, acyl group, sulfonyl group, and carbamoyl group.

9. A yellow light emitting compound as claimed in claim 8, wherein the yellow light emitting compound having the electron absorptive group has the following structural formula 2.

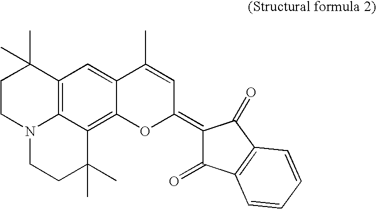

10. A yellow light emitting compound as claimed in claim 9, wherein the yellow light emitting compound having the electron absorptive group has the following structural formula 3.

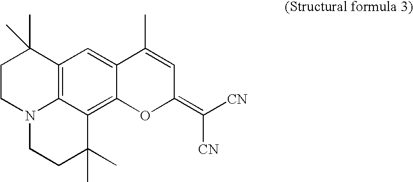

11. A yellow light emitting compound as claimed in claim 9, wherein the yellow light emitting compound having the electron absorptive group has the following structural formula 4.

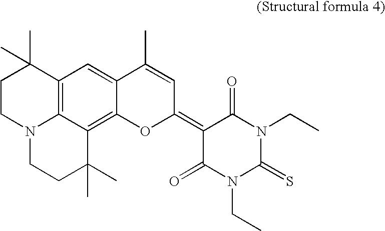

12. A yellow light emitting compound as claimed in claim 9, wherein the yellow light emitting compound having the electron absorptive group has the following structural formula 5.

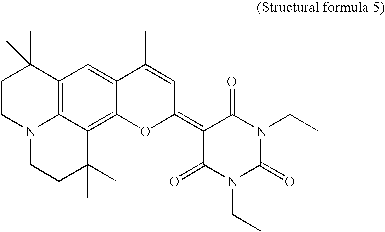

13. An organic EL display having a first electrode, a second electrode, and an organic EL layer formed between the two electrodes, wherein the organic EL layer contains a dopant having a structural formula 1. 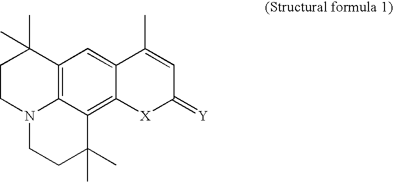
Where, X represents O, S, or N—R, wherein R represents a hydrogen, an aliphatic hydrocarbon, or a heterocyclic compound, and Y represent an alkyl group, a cyclic compound, or a heterocyclic compound containing at least one electron absorptive group.

14. A yellow light emitting compound as claimed in claim 13, wherein the electron absorptive group is selected from a group including cyano group, oxycarbonyl group, acyl group, sulfonyl group, and carbamoyl group.

15. A yellow light emitting compound as claimed in claim 13, wherein the yellow light emitting compound having the electron absorptive group has the following structural formula 2.

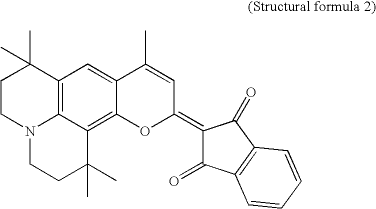

16. A yellow light emitting compound as claimed in claim 13, wherein the yellow light emitting compound having the electron absorptive group has the following structural formula 3.

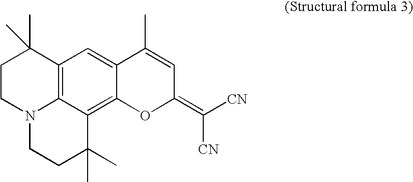

17. A yellow light emitting compound as claimed in claim 13, wherein the yellow light emitting compound having the electron absorptive group has the following structural formula 4.

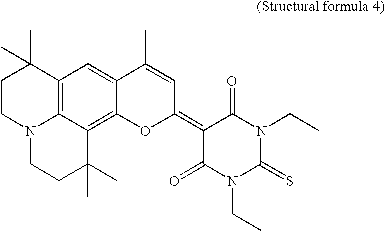

18. A yellow light emitting compound as claimed in claim 13, wherein the yellow light emitting compound having the electron absorptive group has the following structural formula 5. [chemical structure]
